(19) United States
(12) Patent Application Publication
(10) Pub. No.: US 2025/0063962 A1
(43) Pub. Date: Feb. 27, 2025

(54) MOUNTING ASSEMBLY FOR AN AGRICULTURAL IMPLEMENT

(71) Applicant: CNH Industrial America LLC, New Holland, PA (US)

(72) Inventors: Austin Joseph Lewandowski, Congerville, IL (US); Brian Michael Craig, Congerville, IL (US); Jeffry Scott Huber, Eureka, IL (US)

(21) Appl. No.: 18/809,968

(22) Filed: Aug. 20, 2024

Related U.S. Application Data
(60) Provisional application No. 63/578,748, filed on Aug. 25, 2023.

(51) Int. Cl. A01B 15/14

(52) U.S. Cl. CPC A01B 15/14

(57) ABSTRACT

An implement includes a row unit including a row unit frame, a coulter disc, and a mounting assembly for supporting the coulter disc. The mounting assembly includes a mounting bracket including a mounting plate and upper and lower plates rigidly coupled to the mounting plate. The mounting bracket is coupled to the row unit frame and configured to be positionally adjusted to adjust the position of the coulter disc in a first direction. Additionally, the mounting assembly includes a first support arm coupled to the mounting bracket between the upper and lower plates and configured to be positionally adjusted to adjust the position of the coulter disc in a second direction. Furthermore, the mounting assembly includes a second support arm coupled between the first support arm and the coulter disc and configured to be positionally adjusted to adjust the position of the coulter disc in a third direction.

### CROSS-REFERENCE TO RELATED APPLICATIONS

This application is based upon and claims the right of priority to U.S. Provisional Patent Application No. 63/578,748, filed on Aug. 25, 2023, the disclosure of which is hereby incorporated by reference herein in its entirety for all purposes.

### FIELD OF THE INVENTION

The present subject matter relates generally to agricultural implements, such as strip tillage implements and, more particularly, to a mounting assembly for mounting a ground-engaging tool relative to an agricultural implement that allows for the relative position of the tool to be adjusted in multiple directions.

### BACKGROUND OF THE INVENTION

It is well known that, to attain the best agricultural performance from a field, a farmer must cultivate the soil, typically through a tillage operation. Modern farmers perform tillage operations by pulling an agricultural implement, such as a strip tillage implement, behind an agricultural work vehicle, such as a tractor. For example, strip tillage implements generally include ground-engaging tools for tilling the soil of the field in narrow strips during the performance of a strip tillage operation. Such ground-engaging tools often include one or more row cleaner discs, coulter discs, shanks or knives, and/or finishing or conditioning units supported on individual row units of the strip tillage implement. Each ground-engaging tool, in turn, is configured to be moved relative to the soil within the field as the strip tillage implement travels across the field. Such movement of the ground-engaging tools loosens and/or otherwise agitates the soil to prepare the field for subsequent planting operations.

During operation of a strip tillage implement, it is often important to ensure that the various ground-engaging tools are positioned relative to one another in a desired manner to ensure that proper engagement or working of the soil occurs as the implement makes a pass across the field. In this regard, it is generally known to include position adjustment structure that allows the position of a ground-engaging tool to be adjusted in a given direction relative to another portion of the row unit. However, in many instances, the ability to adjust the position of a ground-engaging tool in a single direction is insufficient to properly set up the row unit for optimal performance.

Accordingly, an improved mounting assembly for mounting a ground-engaging tool relative to an agricultural implement that allows for the relative position of the tool to be adjusted in multiple directions be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to an agricultural system. The agricultural system includes a row unit including a row unit frame. Additionally, the agricultural system includes a ground-engaging tool configured to engage soil of a field as an agricultural implement traverses the field. Furthermore, the agricultural system includes a mounting assembly configured to support the ground-engaging tool relative to the row unit frame. The mounting assembly includes a mounting bracket coupled to the row unit frame. The mounting bracket is configured to be positionally adjusted relative to the row unit frame to adjust a position of the ground-engaging tool relative to the row unit frame in a first direction. Additionally, the mounting bracket includes a mounting plate, an upper plate rigidly coupled to the mounting plate, and a lower plate rigidly coupled to the mounting plate. Moreover, the mounting assembly includes a first support arm coupled to the mounting bracket between the upper plate and the lower plate. The first support arm is configured to be positionally adjusted relative to the mounting bracket to adjust the position of the ground-engaging tool relative to the row unit frame in a second direction differing from the first direction. Additionally, the mounting assembly includes a second support arm coupled between the first support arm and the ground-engaging tool. The second support arm is configured to be positionally adjusted relative to the first support arm to adjust the position of the ground-engaging tool relative to the row unit frame in a third direction differing from the first and second directions.

In another aspect, the present subject matter is directed to an agricultural implement. The agricultural implement includes a toolbar and a row unit coupled to the toolbar, the row unit including a row unit frame. Additionally, the agricultural implement includes a coulter disc configured to engage soil of a field as the agricultural implement traverses the field. Furthermore, the agricultural implement includes a mounting assembly configured to support the coulter disc relative to the row unit frame. The mounting assembly includes a mounting bracket coupled to the row unit frame. The mounting bracket is configured to be positionally adjusted relative to the row unit frame to adjust a position of the coulter disc relative to the row unit frame in a first direction. Additionally, the mounting bracket includes a mounting plate, an upper plate rigidly coupled to the mounting plate, and a lower plate rigidly coupled to the mounting plate. Moreover, the mounting assembly includes a first support arm coupled to the mounting bracket between the upper plate and the lower plate. The first support arm is configured to be positionally adjusted relative to the mounting bracket to adjust the position of the coulter disc relative to the row unit frame in a second direction differing from the first direction. Additionally, the mounting assembly includes a second support arm coupled between the first support arm and the coulter disc. The second support arm is configured to be positionally adjusted relative to the first support arm to adjust the position of the coulter disc relative to the row unit frame in a third direction differing from the first and second directions.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of an agricultural implement in accordance with aspects of the present subject matter;

FIG. 2 illustrates a side view of one embodiment of a row unit suitable for use with the implement shown in FIG. 1 in accordance with aspects of the present subject matter;

FIG. 3 illustrates a perspective view of one embodiment of a tool mounting assembly in accordance with aspects of the present subject matter;

FIG. 4 illustrates another perspective view of the embodiment of the tool mounting assembly shown in FIG. 3, particularly an assembled mounting bracket, a first support arm, and a second support arm of the tool mounting assembly;

FIG. 5 illustrates a partially exploded view of the embodiment of the tool mounting assembly shown in FIG. 3, particularly illustrating the first support arm disassembled from the tool mounting assembly; and

FIG. 6 illustrates a partially exploded view of the embodiment of the tool mounting assembly shown in FIG. 3, particularly illustrating the second support arm disassembled from the tool mounting assembly 88.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to an agricultural implement. The agricultural implement, which may be configured as a strip tillage implement, includes a toolbar and one or more row units coupled to the toolbar.

Each row unit includes a row unit frame supporting one or more ground-engaging tools, such as side coulter discs. In one embodiment, the row unit may include a pair of first side coulter discs, which are configured to break out the soil along the width of the row being worked or formed by the row unit. The row unit may further include a pair of second side coulter discs mounted aft of the pair of first side coulter discs, which are configured to catch or block the soil coming off of the first side coulter discs and redirect such soil back towards the center of the row being formed by the row unit.

Furthermore, the agricultural implement may include a mounting assembly configured to support one of the ground-engaging tools of the row unit. For example, in one embodiment, the mounting assembly may be configured to support one of the second side coulter discs relative to the row unit frame. Additionally, the mounting assembly is configured to be positionally adjustable relative to a frame of the row unit to allow the corresponding position of the tool supported thereby to be similarly adjusted. For instance, in one embodiment, the mounting assembly may include a mounting bracket coupled to the row unit frame and configured to be positionally adjusted relative to the row unit in a first direction, such as along a fore-aft direction of the row unit. Additionally, the mounting assembly may include a first support arm coupled to the mounting bracket and configured to be positionally adjusted relative to the mounting bracket in a second direction differing from the first direction, such as along a lateral direction of the row unit. Moreover, the mounting assembly may include a second support arm coupled between the first support arm and the ground-engaging tool and configured to be positionally adjusted relative to the first support arm in a third direction differing from the first and second directions, such as along a vertical direction of the row unit. As a result, by adjusting the relative positions of the components of the mounting assembly in one, two or all of the associated directions, the position of the ground-engaging tool supported thereby may be similarly adjusted in such direction(s).

Additionally, in several embodiments, the mounting assembly may also be configured to allow an angular orientation of the ground-engaging tool to be adjusted. For instance, in one embodiment, the first support arm may be configured to be pivotably coupled to the mounting bracket in a manner that allows an angular orientation of the first support arm to be adjusted by pivoting the support arm relative to the mounting bracket about a pivot axis. In such an embodiment, by pivoting the first support arm relative to the mounting bracket about the pivot axis, an angular orientation of the ground-engaging tool may be adjusted in a corresponding manner.

In several embodiments, the disclosed mounting assembly will generally be described herein with reference to supporting one of the aft or second side coulter discs of the row unit relative to the row unit frame. In this regard, the mounting assembly may allow for the position and/or angular orientation of a second side coulter disc to be adjusted in a manner that generally improves the operation of the row unit and associated agricultural implement. Generally, the soil properties (e.g., compaction of the soil) and/or the agricultural implement properties (e.g., force applied to ground-engaging tools) affect the amount of soil displaced by the pair of forward or first side coulter discs. For example, less compacted soil and/or a greater force applied to the first side coulter discs may result in a larger amount of soil displaced by the first side coulter discs, while more compacted soil and/or a lesser force applied to the first side coulter discs may result in a smaller amount of soil displaced by the first side coulter discs. As such, the positional adjustments permitted by the disclosed mounting assembly may allow the second side coulter disc to block and/or redirect the soil as desired.

It should also be appreciated that, although the disclosed mounting assembly will generally be described herein with reference to side coulter discs, the mounting assembly may generally be configured to support any suitable ground-engaging tool(s) relative to an associated agricultural implement.

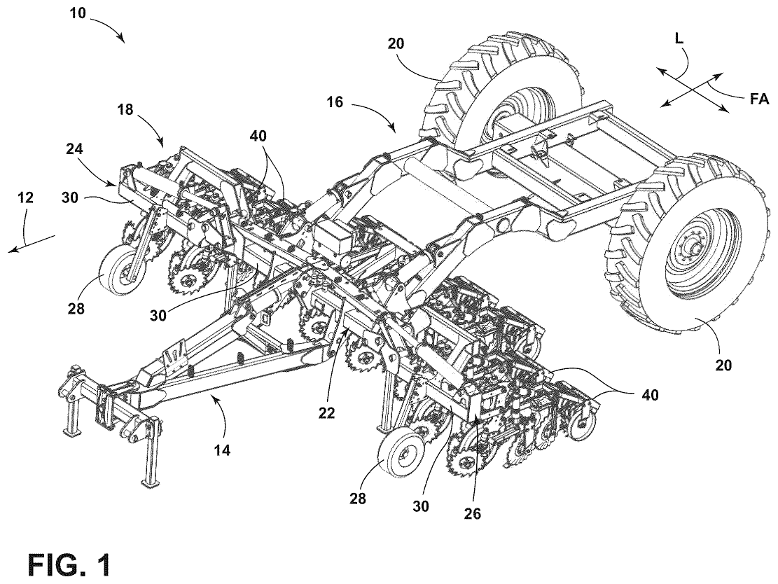

Referring now to the drawings, FIG. 1 illustrates a perspective view of one embodiment of an agricultural implement 10 in accordance with aspects of the present subject matter. In general, the implement 10 may be configured to be towed across a field in a forward direction of travel (e.g., as indicated by arrow 12 in FIG. 1) by a work vehicle (e.g., an agricultural tractor). As shown, the implement 10 is configured as a strip tillage implement. However, in other embodiments, the implement 10 may be configured as any other suitable type of implement, such as a seed-planting implement, a fertilizer-dispensing implement, and/or the like.

As shown in FIG. 1, the implement 10 includes a towbar assembly 14, a chassis assembly 16, and a toolbar assembly 18. As is generally understood, the towbar assembly 14 may be configured to allow the implement 10 to be coupled to a tow vehicle (e.g., a tractor) for towing the implement 10 along a field during the performance of a strip-tillage operation. For instance, the towbar assembly 14 may incorporate a hitch or other suitable coupling for connecting the implement 10 to a tow vehicle. In one embodiment, the chassis assembly 16 may be configured to support one or more storage tanks (not shown). For instance, the storage tank(s) may correspond to a fertilizer tank or any other suitable type of storage tank configured to store an agricultural material. Additionally, the chassis assembly 16 may be coupled to one or more pairs of chassis support wheels 20. For example, as shown in FIG. 1, a pair of support wheels 20 are coupled to the aft end of the chassis assembly 16 to support the implement 10 relative to the ground.

It should be appreciated that, in the illustrated embodiment, the chassis assembly 16 is positioned at the aft end of the implement 10 such that the toolbar assembly 18 is disposed between the towbar assembly 14 and the chassis assembly 16 along the fore-aft direction of the implement 10 (as indicated by arrow FA in FIG. 1). For instance, as shown in FIG. 1, toolbar assembly 18 is pivotably coupled at its forward end to the towbar assembly 14 and at its aft end to the chassis assembly 16. Alternatively, the chassis assembly 16 may be positioned between the towbar assembly 14 and the toolbar assembly 18 in the fore-aft direction FA of the implement 10 such that the toolbar assembly 18 is disposed at the aft end of the implement 10. In such an embodiment, the forward end of the toolbar assembly 18 may be coupled to the aft end of the chassis assembly 16 (e.g., via connecting frame).

In several embodiments, the toolbar assembly 18 may be configured as a winged toolbar assembly. Specifically, as shown in FIG. 1, the toolbar assembly 18 includes a central toolbar section 22 and one or more wing toolbar sections coupled to and extending laterally (e.g., in the lateral direction L) from central toolbar section 22 (e.g., a first wing toolbar section 24 coupled to one lateral end of the central toolbar section 22 and a second wing toolbar section 26 coupled to the opposed lateral end of the central toolbar section 22). Additionally, as shown in FIG. 1, a wing support wheel 28 may be coupled to each wing toolbar section 24, 26 (e.g., at the front of each wing toolbar section 24, 26) to support the toolbar section 24, 26 relative to the ground. In one embodiment, the wing support wheels 28 may be configured to function as gauge wheels for the wing toolbar sections 24, 26.

As is generally understood, each of the various toolbar sections 22, 24, 26 may include one or more laterally extending toolbars 30 configured to support a plurality of row units 40. For instance, in one embodiment, each row unit 40 may be coupled to its respective toolbar 30 via a four-bar linkage. In the illustrated embodiment, the row units 40 are configured as strip tillage units. As such, each row unit 40 may include one or more ground-engaging tools for working the soil in narrow strips extending in the forward direction of travel 12 of implement 10. For instance, in one embodiment, each row unit 40 may include one or more row cleaner discs, coulter discs, shanks or knives, finishing or conditioning units, and/or the like for tilling narrow strips of soil during the performance of a strip tillage operation. Additionally, each row unit 40 may also incorporate one or more components for supplying agricultural materials to the soil, such as injectors or tubes for directing agricultural material (e.g., fertilizer) supplied from a storage tank supported on the chassis assembly 16 (or from any other source) into the worked soil.

It should be appreciated that the configuration of the implement 10 described above and shown in FIG. 1 is provided only to place the present subject matter in an exemplary field of use. Thus, it should be appreciated that the present subject matter may be readily adaptable to any manner of implement configuration.

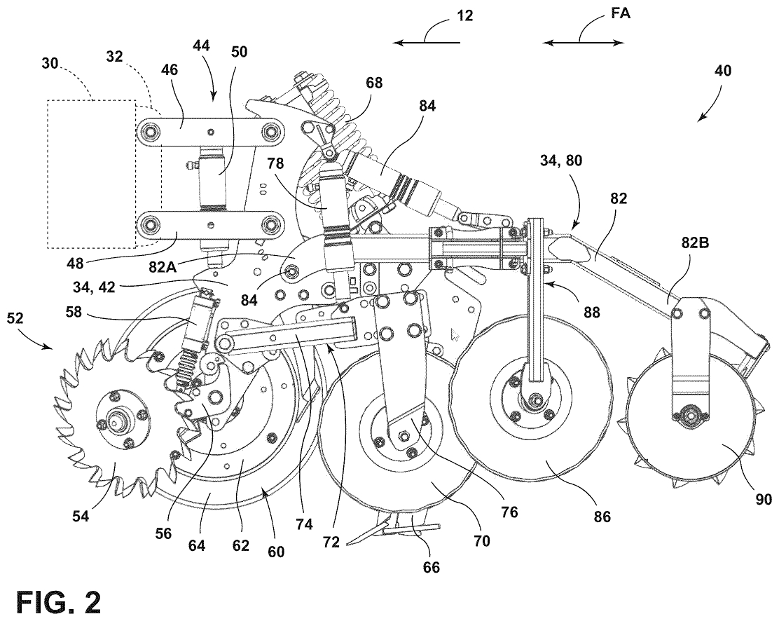

Referring now to FIG. 2, a side view of one embodiment of a row unit 40 suitable for use with the implement 10 shown in FIG. 1 is illustrated in accordance with aspects of the present subject matter. The row unit 40 may include a row unit frame 34 that may include one or more frame portions. For example, as shown in FIG. 2, the row unit frame 34 includes a main frame or backbone 42 (referred to herein as simply the “frame 42” of the row unit 40) configured to be adjustably coupled to a toolbar (e.g., toolbar 30 and associated mounting bracket(s) 32) of the implement 10 via a linkage assembly 44. For example, in one embodiment, the frame 42 may be coupled to the toolbar 30 via a four-bar linkage including one or more pairs of first and second linkages 46, 48, with one end of each linkage 46, 48 being pivotably coupled to the frame 42 and the opposed end of each linkage 46, 48 being pivotably coupled to the toolbar 30 (e.g., via the associated mounting bracket(s) 32). However, it should be appreciated that, in alternative embodiments, the frame 42 of the row unit 40 may be coupled to the toolbar 30 in any other suitable manner. Additionally, the row unit 40 may include one or more downforce actuators 50 provided in operative association with the linkage assembly 44 for applying a downforce to the row unit 40. In one embodiment, the downforce actuators 50 may be passive actuators, such as air shocks or springs. Alternatively, the downforce actuators 50 may be actively controlled actuators, such as pneumatic or hydraulic cylinders.

Moreover, as shown in FIG. 2, the row unit 40 may include a plurality of ground-engaging tools coupled to and/or supported by the frame 42. For instance, in several embodiments, the row unit 40 may include a row cleaner assembly or “row cleaner” 52 positioned at the forward end of the row unit 40 relative to the forward direction of travel 12. In general, the row cleaner 52 may be configured to break up and/or sweep away residue, dirt clods, and/or the like from the travel path of the various components positioned downstream or aft of the row cleaner 52. In one embodiment, the row cleaner 52 may include a pair of row cleaner discs 54 (only one of which is shown in FIG. 2), with each disc 54 being pivotably coupled to the main frame via a respective row cleaner arm 56. As is generally understood, the row cleaner discs 54 may be toothed or spiked, such as by including a plurality of fingers or teeth extending radially outwardly from a central disc hub. As such, the discs 54 may be configured to roll relative to the soil as the implement 10 is moved across the field such that the teeth break up and/or sweep away residue and dirt clods. Additionally, as shown in FIG. 2, the row unit 40 may also include one or more row cleaner actuators 58 provided in association with the row cleaner 52. For instance, in the illustrated embodiment, the row unit 40 includes a pair of row cleaner actuators 58 (only one of which is shown in FIG. 2) configured to provide a downward biasing force against the row cleaner 52, with each row cleaner actuator 58 being coupled between the main frame 42 and a respective row cleaner arm 56. In one embodiment, the row cleaner actuators 58 may be passive actuators, such as air shocks or springs. Alternatively, the row cleaner actuators 58 may be actively controlled actuators, such as pneumatic or hydraulic cylinders.

Moreover, as shown in FIG. 2, the row unit 40 may also include a center coulter 60 positioned immediately aft of the row cleaner 52 relative to the forward direction of travel 12 of the implement 10. The center coulter 60 may generally be aligned with a longitudinal centerline of the row unit 40 such that the coulter 60 is positioned in the center of the row unit 40 relative to the lateral direction L of the implement 10 (i.e., the direction into and out of the page in FIG. 2). In one embodiment, the center coulter 60 may include a central hub 62 coupled to the main frame 42 for rotation relative thereto and a peripheral blade 64 extending radially outwardly from the hub 62 around its outer perimeter. The center coulter 60 may generally be configured to cut a slot or slit within the field along the center of the “row” being processed or formed by the row unit 40. Additionally, the center coulter 60 may also function together with the row cleaner 52 to ensure that residue and other trash is swept or moved laterally away from the travel path of further downstream components of the row unit 40. For instance, in one embodiment, as the row cleaner discs 54 rotate relative to the ground, the discs 54 may be configured to trap residue against the surface of the field. The blade 64 of center coulter 60 may then slice or cut through the trapped residue extending between the pair of row cleaner discs 54, thereby allowing the cut residue to be swept away from the longitudinal centerline of the row unit 40 via the action of the row cleaner discs 54.

Referring still to FIG. 2, in several embodiments, the row unit 40 may include a centralized shank 66 mounted to the main frame 42 at a location aft of the central hub 62 relative to the forward direction of travel 12 of the implement 10. In one embodiment, the shank 66 may generally be aligned with the center coulter 60 along the longitudinal centerline of the row unit 40 (i.e., aligned with the center coulter 60 in the longitudinal direction of the implement 10). The shank 66 may be configured to break out the soil along the lateral width of the row being formed by the row unit 40 at a location aft of the center coulter 60. For example, the shank 66 may be aligned with the blade 64 of the center coulter 60 such that the shank 66 travels through and breaks open the slit or slot cut into the soil via the center coulter 60. As shown in FIG. 2, the row unit 40 may also include one or more shank actuators 68 provided in association with the shank 66 for providing a downward biasing force thereto. For instance, in the illustrated embodiment, the row unit 40 includes a pair of shank actuators 68, with each shank actuator 68 being coupled between the main frame 42 and the shank 66. In one embodiment, the shank actuators 68 may be passive actuators, such as air shocks or springs. Alternatively, the shank actuators 68 may be actively controlled actuators, such as pneumatic or hydraulic cylinders. In alternative embodiments, the shank 66 may be replaced with a different ground-engaging tool, such as centralized knife positioned immediately aft of the center coulter 60.

Additionally, in several embodiments, the row unit 40 may include a forward or first pair of side coulter discs 70 (only one of which is shown in FIG. 2) positioned immediately aft of the center coulter 60 relative to the forward direction of travel 12, with each first side coulter disc 70 being disposed along either side of the shank 66 such that the discs 70 are spaced apart from the shank 66 in the lateral direction L of the implement 10. In one embodiment, each first side coulter disc 70 is pivotably coupled to the main frame 42 via a first side coulter mount assembly 72. For instance, as shown in FIG. 2, the side coulter arm assembly 72 includes a mounting arm 74 and a support arm 76, with the mounting arm 74 being pivotably coupled to the main frame 42 at one end and being coupled to the support arm 76 at the other end. The support arm 76 may, in turn, be coupled between the mounting arm 74 and its respective first side coulter disc 70 in a manner that allows the coulter disc 70 to rotate relative to the support arm 76 as the row unit 40 is being moved across the field. As shown in FIG. 2, the row unit 40 may also include one or more side coulter actuators 78 provided in association with the side coulters 78 for applying a downward biasing force thereto. For instance, in the illustrated embodiment, the row unit 40 includes a pair of side coulter actuators 78 (only one of which is shown in FIG. 2), with each side coulter actuator 78 being coupled between the main frame 42 and a respective coulter arm assembly 72. In one embodiment, the side coulter actuators 78 may be passive actuators, such as air shocks or springs. Alternatively, the side coulter actuators 78 may be actively controlled actuators, such as pneumatic or hydraulic cylinders.

In several embodiments, the side coulter discs 70 may function together with the central shank 66 to break out the soil along the width of the strip being worked or formed by the row unit 40. For instance, the side coulter discs 70 may be configured to “score” the soil to provide a pre-fracture at the desired width of the strip being formed. As an example, the side coulter discs 70 may be configured to run at a relatively shallow depth (e.g., 1-2 inches) to create scores or fracture lines” within the soil along the lateral edges of the row being formed. The shank 66 may, in turn, be configured to break out the hard soil across the lateral width extending between the fracture lines created by the side coulter discs 70.

Moreover, in several embodiments, the row unit frame 34 of the row unit 40 may include an aft frame assembly 80 coupled to the main frame 42 for supporting additional ground-engaging tools of the row unit 40. As shown in FIG. 2, the aft frame assembly 80 may include a pair of aft frame members 82 (only one of which is shown in FIG. 2) extending between a forward end 82A and an aft end 82B, with the forward end 82A of each frame member 82 being pivotably coupled to the main frame 42 at a forward pivot point 44. Each frame member 82 extends rearwardly from the pivot point 44 relative to the forward direction of travel 12 to its aft end 82B positioned adjacent to the aft end of the row unit 40. Additionally, in one embodiment, the row unit 40 may include one or more aft frame actuators 84 provided in association with the aft frame assembly 80 for providing a downward biasing force to the frame assembly 80 (and any ground-engaging tools supported thereby). For instance, in the illustrated embodiment, the row unit 40 includes a pair of aft frame actuators 84 (only one of which is shown in FIG. 2), with each aft frame actuator 84 being coupled between the main frame 42 and a respective aft frame member 82 of the aft frame assembly 80. In one embodiment, the aft frame actuators 84 may be passive actuators, such as air shocks or springs. Alternatively, the aft frame actuators 84 may be actively controlled actuators, such as pneumatic or hydraulic cylinders.

As shown in FIG. 2, in several embodiments, the aft frame assembly 80 may be configured to support an aft or second pair of side coulter discs 86 positioned aft or rearward of the forward or first pair of side coulter discs 70 (and aft of the shank 66) relative to the forward direction of travel 12, with each second side coulter disc 86 being disposed along either side of the longitudinal centerline of the row unit 40 such that the discs 86 are spaced apart from the centerline in the lateral direction L of the implement 10. In one embodiment, the second side coulter discs 86 may be configured to catch or block the soil coming off of the first side coulter discs 70 and shank 66 and redirect such soil back towards the center of the row being formed. As a result of redirecting the thrown soil back towards the center of the row, the aft or second side coulter discs 86 may function as “berm builders” to create a berm of soil along the centerline of the row unit 40. In such instance, the second side coulter discs 86 may be set to run at a relatively shallow depth (e.g., 1 inch or less) so that the coulter discs 86 can catch the soil without effectively tilling the soil. Alternatively, the second side coulter discs 86 may be set at a less shallow depth to allow the coulter discs 86 to perform shallow tillage (e.g., to widen the strip of worked soil beyond what the first side coulter discs 70 achieved) while still performing the function of directing soil into the right lateral shape to build a proper berm across the width of the row. In one embodiment, each second side coulter disc 86 is coupled to the aft frame assembly 80 via a tool mounting assembly 88. In one embodiment, the tool mounting assembly 88 may be configured to allow the positioning of the second side coulter discs 86 to be adjusted relative to the other tools of the row unit 40, thereby allowing the coulter discs 86 to be set properly for performing their soil-catching function.

Moreover, as shown in FIG. 2, the row unit 40 may also include a finishing tool positioned at the aft end of the row unit 40. Specifically, in the illustrated embodiment, the row unit 40 includes a strip conditioner 90 coupled to the aft end 82B of the aft frame assembly 80. In general, the strip conditioner 90 may have any suitable configuration that allows it to perform its function as a finishing tool. In one embodiment, the strip conditioner 90 may be configured as a spider conditioner that functions to reduce the size of soil clods across the width of the row being formed. In other embodiments, a conditioning reel or basket may be used as the finishing tool.

It should be appreciated that the configuration of the row unit 40 described above and shown in FIG. 2 is provided only to place the present subject matter in an exemplary field of use. Thus, it should be appreciated that the present subject matter may be readily adaptable to any manner of row unit configuration.

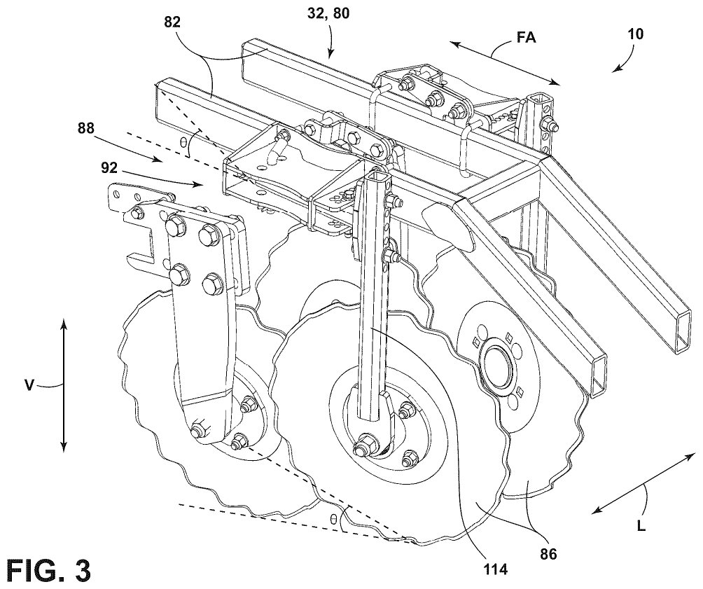

Referring now to FIG. 3, a perspective view of one embodiment of a tool mounting assembly 88 is illustrated in accordance with aspects of the present subject matter. As shown in FIG. 3, the tool mounting assembly 88 includes a mounting bracket 92 coupling the tool mounting assembly 88 to a portion of the row unit frame 34, such as one of the aft frame members 82 of the aft frame assembly 80. As will be described below, a position of the mounting bracket 92 may be adjusted relative to the adjacent portion of the row unit frame 34 along the fore-aft direction of the row unit 40 (as indicated by arrow FA in FIG. 3) to allow the position of the second side coulter disc 86 to be similarly adjusted along the fore-aft direction FA.

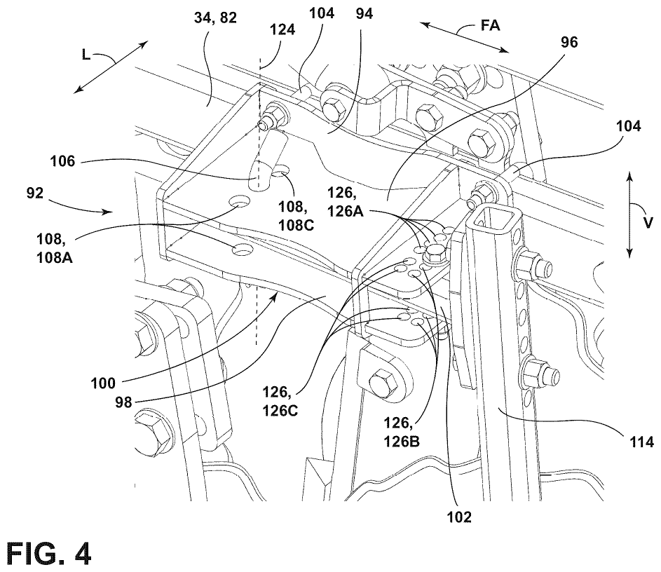

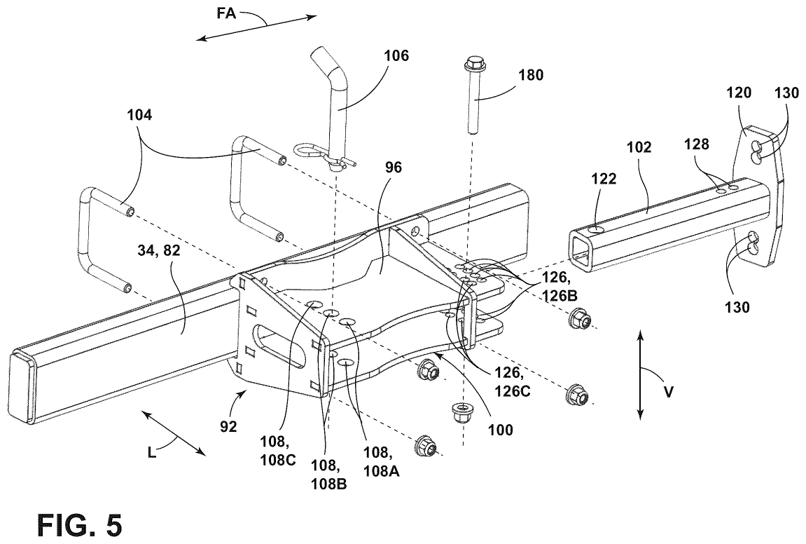

Additionally, the tool mounting assembly 88 includes a first support arm 102 coupled to the mounting bracket 92. As will be described below, a position of the first support arm 102 may be adjusted relative to the mounting bracket 92 along the lateral direction of the row unit 40 (as indicated by arrow L in FIG. 3) to allow the position of the second side coulter disc 86 to be similarly adjusted along the lateral direction L. Furthermore, as will be described below, a fastener (e.g., second 106 (FIGS. 4, 5)) may also couple the first support arm 102 to the mounting bracket 92 and define a pivot axis 124 (FIG. 4) about which an angular orientation (as indicated by angle θ in FIG. 3) of the first support arm 102 is adjusted which, in turn, results in an angular orientation θ (FIG. 3) of the second side coulter disc 86 being adjusted relative to the row unit frame 34.

Furthermore, the tool mounting assembly 88 includes a second support arm 114 extending along a vertical direction (as indicated by arrow V in FIG. 3) of the implement 10 from a first end coupled to the first support arm 102 to a second end coupled to a bracket of the second side coulter disc 86. The position of the second support arm 114 may be adjusted relative to the first support arm 102 in the vertical direction V of the row unit 40 to allow the vertical position of the second side coulter disk 86 to be similarly adjusted along the vertical direction V.

Positional adjustment of the mounting bracket 92, the first support arm 102, and/or the second support arm 114, and, thus, positional adjustment of the second side coulter disc 86 improves the operation of the agricultural implement 10 by allowing control over the amount of displaced soil that is blocked by the second side coulter disc 86 and/or redirection of displaced soil by the second side coulter disc 86.

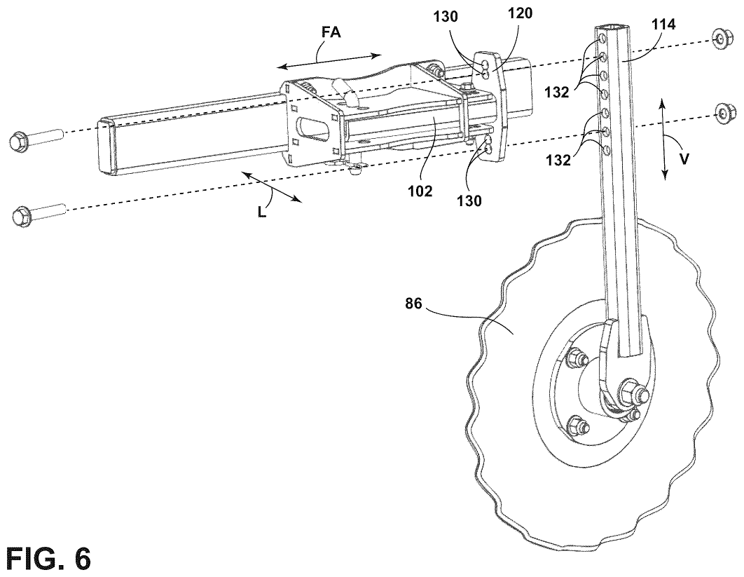

Referring now to FIGS. 4-6, differing perspective views of the embodiment of the tool mounting assembly 88 shown in FIG. 3 are illustrated in accordance with aspects of the present subject matter. Specifically, FIG. 4 illustrates a perspective view of the assembled mounting bracket 92, a first support arm 102, and a second support arm 114 of the tool mounting assembly 88. Additionally, FIG. 5 illustrates a partially exploded perspective view of the first support arm 102 disassembled from the tool mounting assembly 88. Moreover, FIG. 6 illustrates a partially exploded perspective view of the second support arm 114 disassembled from the tool mounting assembly 88.

The mounting bracket 92 may include a mounting plate 94 with one or more first fasteners 104 extending therethrough and coupling the mounting plate 94 to a portion of the row unit frame 34. As shown in FIG. 4, the first fastener(s) 104 couple the mounting plate 94 to the aft frame member 82. Furthermore, the first fastener(s) 104 are configured to allow the position of the mounting bracket 92 to be adjusted along the row unit frame 34 in the fore-aft direction FA (as indicated by arrow FA in FIGS. 4-6) of the row unit 40. In this respect, adjustment of the position of the mounting bracket 92 relative to the row unit frame 34 in the fore-aft direction FA results in the position of the second side coulter disc 86 (FIGS. 2, 3, 6) being adjusted in the fore-aft direction. For example, as shown in FIG. 4, the first fastener(s) 104 are configured as U-bolt assemblies which may be loosened to allow the mounting bracket 92 to slide along the aft frame member 82 and tightened when the second coulter disc 86 (FIGS. 2, 3, 6) is in a desired position in the fore-aft direction FA. However, it should be appreciated that the first fastener(s) 104 may be configured as any suitable fastener coupling the mounting plate 94 to the row unit frame 34 and being configured to allow the position of the mounting bracket 92 to be adjusted along the row unit frame 34 in the fore-aft direction FA. For example, the first fastener(s) 104 may be configured as axial bolts. As such, the row unit frame 34, such as the aft frame member 82, and the mounting plate 94 may each define a plurality of fastener holes (not shown) configured to receive the axial bolts therethrough. The fastener holes (not shown) may be spaced apart along the fore-aft direction FA such that the position of the mounting bracket 92 may be adjusted along the row unit frame 34 in the fore-aft direction FA by aligning the fastener holes (not shown) of the mounting bracket 92 and the fastener holes (not shown) of the aft frame member 82 in various ways.

Additionally, as shown in FIGS. 4 and 5, the mounting bracket 92 may include an upper plate 96 and a lower plate 98 rigidly coupled to the mounting plate 94. As such, upper plate 96 and the lower plate 98 are not configured to move relative to the mounting plate 94. Furthermore, the upper plate 96 and the lower plate 98 may be positioned relative to each other in the vertical direction (as indicated by arrow V in FIGS. 4-6) such that the first support arm 102 is received therebetween. For example, the upper plate 96 and the lower plate 98 may be spaced apart in the vertical direction V such that a vertical gap 100 is defined between the upper plate 96 and the lower plate 98. As such, the first support arm 102 may be received within the vertical gap 100 and coupled to the upper plate 96 and the lower plate 98 with, for example, a second fastener 106 and a third fastener 180 (FIG. 5). Additionally, since the upper plate 96 and the lower plate 98 are rigidly coupled to the mounting plate 94, the upper plate 96 and the lower plate 98 provide structural reinforcement to the first support arm 102 that limits bending of the first support arm 102 during strip tilling operations.

Moreover, as shown in FIG. 4, the first support arm 102 may be coupled to the upper plate 96 and the lower plate 98 between the upper plate 96 and the lower plate 98 and configured to be positionally adjusted in the lateral direction (as indicated by arrow L in FIGS. 4-6) relative to the mounting bracket 92. For example, in several embodiments, the first support arm 102 may be coupled to the upper plate 96 and the lower plate 98 by the second fastener 106, such as a hitch pin, extending through all three of the upper plate 96, the first support arm 102, and the lower plate 98. In this respect, as shown in FIGS. 4 and 5, the upper plate 96 and the lower plate 98 each define a first plurality of fastener holes 108, with the plates 96, 98 being oriented such that the first plurality of fastener holes 108 are spaced apart along the lateral direction of the row unit 40. Likewise, the first support arm 102 defines a first fastener hole 122. As such, the second fastener 106 may couple the first support arm 102 to the upper plate 96 and the lower plate 98 when the first fastener hole 122 of the first support arm 102 is aligned with an aligned pair of first fastener holes 108 of the first plurality of fastener holes 108 defined by the upper plate 96 and the lower plate 98 and the second fastener 106 extends through both the first fastener hole 122 and the aligned pair of first fastener holes 108. As shown in FIG. 5, first, second, and third aligned pairs of first fastener holes 108A, 108B, 108C are defined by the upper plate 96 and the lower plate 98. In this regard, the first support arm 102 may be configured to be adjusted in the lateral direction L relative to the mounting bracket 92 by aligning the first fastener hole 122 with one of the aligned pairs of first fastener holes 108. Adjustment of the position of the first support arm 102 relative to the mounting bracket 92 in the lateral direction L results in the position of the second side coulter disc 86 (FIGS. 2, 3, 6) being adjusted in the lateral direction L.

It should be appreciated that the second fastener 106 may be configured as any suitable fastener and any suitable number of fasteners configured to couple the first support arm 102 to the upper plate 96 and the lower plate 98 of the mounting bracket 92 and allow the position of the first support arm 102 to be adjusted between the upper plate 96 and the lower plate 98 along the lateral direction.

Additionally, the first support arm 102 may be configured to be positionally adjusted such that the angular orientation (as indicated by angle θ in FIG. 3) of the first support arm 102 is adjusted relative to the mounting bracket 92, such as the angular orientation θ (FIG. 3) relative to a vertical plane extending parallel or perpendicular to the forward-aft direction FA. As shown in FIG. 4, a pivot axis 124 may be defined between the first support arm 102 and the mounting bracket 92 via the pinned connection provided by the second fastener 106. Furthermore, as shown in FIG. 5, the upper plate 96 and the lower plate 98 each define a second plurality of fastener holes 126. The upper plate 96 and the lower plate 98 are oriented such that the second plurality of fastener holes 126 are spaced apart along the lateral direction L of the row unit 40. Moreover, the first support arm 102 defines one or more second fastener holes 128. In this respect, the first support arm 102 is configured to be pivoted about the pivot axis 124 to adjust the angular orientation θ (FIG. 3) of the first support arm 102 relative to the mounting bracket 92 by aligning the second fastener hole(s) 128 with an aligned pair of second fastener holes 126 of the second plurality of fastener holes 126 defined by the upper plate 96 and the lower plate 98. As shown in FIGS. 4 and 5, first, second, and third sets of aligned pairs of second fastener holes 126A, 126B, 126C are defined by the upper plate 96 and the lower plate 98. Each different set of aligned pairs of second fastener holes 126A, 126B, 126C is generally associated with a respective aligned pair of first fastener holes 108A, 108B, 108C. As such, the sets of aligned pairs of second fastener holes 126A, 126B, 126C are each provided in an arced array having a different radius of curvature that corresponds to movement of the first support arm 102 as it is pivoted about the second fastener 106. For example, the first set of aligned pairs of second fastener holes 126A may be associated with the first aligned pair of first fastener holes 108A. As such, when the second fastener 106 is inserted through the first aligned pair of first fastener holes 108A, the first support arm 102 may be pivoted about the second fastener 106 to align the second fastener hole(s) 128 of the first support arm 102 with any aligned pair of holes of the first set of aligned pairs of second fastener holes 126A. It should be appreciated that adjustment of the angular orientation θ (FIG. 3) of the first support arm 102 relative to the mounting bracket 92 results in an angular orientation θ (FIG. 3) of the second side coulter disc 86 (FIGS. 2, 3, 6) being adjusted relative to the row unit frame 34.

Additionally, as shown in FIG. 4, the second support arm 114 may be coupled between the first support arm 102 and the second side coulter disc 86 (FIGS. 2, 3, 6) and configured to be positionally adjusted in the vertical direction V relative to the first support arm 102. For example, as shown in FIGS. 5 and 6, the first support arm 102 may include a base 120 defining one or more third fastener holes 130. Furthermore, the second support arm 114 defines a plurality of third fastener holes 132 (FIG. 6) and may be oriented such that the third plurality of fastener holes 132 (FIG. 6) are spaced apart along the vertical direction V of the row unit frame 34. As such, the second support arm 114 may be configured to be adjusted in the vertical direction V relative to the first support arm 102 by aligning the third fastener hole(s) 130 of the first support arm 102 with one of the fastener holes of the third plurality of fastener holes 132 of the second support arm 114. As such, adjustment of the position of the second support arm 114 relative to the first support arm 102 in the vertical direction V results in the position of the second side coulter disc 86 (FIGS. 2, 3, 6) being adjusted in the vertical direction V relative to the row unit frame 34.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An agricultural system, comprising:
a row unit including a row unit frame;
a ground-engaging tool configured to engage soil of a field as an agricultural implement traverses the field; and
a mounting assembly configured to support the ground-engaging tool relative to the row unit frame, the mounting assembly comprising:
a mounting bracket coupled to the row unit frame, the mounting bracket configured to be positionally adjusted relative to the row unit frame to adjust a position of the ground-engaging tool relative to the row unit frame in a first direction, the mounting bracket comprising:
a mounting plate;
an upper plate rigidly coupled to the mounting plate; and
a lower plate rigidly coupled to the mounting plate;
a first support arm coupled to the mounting bracket between the upper plate and the lower plate, the first support arm configured to be positionally adjusted relative to the mounting bracket to adjust the position of the ground-engaging tool relative to the row unit frame in a second direction differing from the first direction; and
a second support arm coupled between the first support arm and the ground-engaging tool, the second support arm configured to be positionally adjusted relative to the first support arm to adjust the position of the ground-engaging tool relative to the row unit frame in a third direction differing from the first and second directions.

2. The agricultural system of claim 1, wherein the second direction extends perpendicular to the first direction and the third direction extends perpendicular to both the first direction and the second direction.

3. The agricultural system of claim 2, wherein the first direction comprises a fore-aft direction of the row unit, the second direction comprises a lateral direction of the row unit, and the third direction comprises a vertical direction of the row unit.

4. The agricultural system of claim 1, wherein:
one or more fasteners extend through the mounting plate, the one or more fasteners coupling the mounting plate to a portion of the row unit frame and being configured to allow a position of the mounting bracket to be adjusted along the row unit frame in a fore-aft direction of the row unit, and
adjustment of the position of the mounting bracket relative to the row unit frame in the fore-aft direction results in the position of the ground-engaging tool being adjusted in the fore-aft direction.

5. The agricultural system of claim 4, the one or more fasteners comprising U-bolt assemblies.

6. The agricultural system of claim 1, wherein:
the upper plate and the lower plate are positioned relative to each other in a vertical direction such that the first support arm is received therebetween and coupled to the upper plate and the lower plate.

7. The agricultural system of claim 1, wherein:
the upper plate and the lower plate each define a first plurality of fastener holes and are each oriented such that the first plurality of fastener holes are spaced apart along a lateral direction of the row unit;
the first support arm defines a first fastener hole and is configured to be adjusted in the lateral direction relative to the mounting bracket by aligning the first fastener hole with an aligned pair of first fastener holes of the first plurality of fastener holes defined by the upper and lower plates; and
adjustment of the position of the first support arm relative to the mounting bracket in the lateral direction results in the position of the ground-engaging tool being adjusted in the lateral direction.

8. The agricultural system of claim 7, wherein:
a pivot axis is defined between the first support arm and the mounting bracket via a fastener extending through the first fastener hole and the aligned pair of first fastener holes;
the upper plate and the lower plate each define a second plurality of fastener holes and are oriented such that the second plurality of fastener holes are spaced apart along the lateral direction of the row unit;
the first support arm defines a second fastener hole and is configured to be pivoted about the pivot axis to adjust an angular orientation of the first support arm relative to the mounting bracket by aligning the second fastener hole with an aligned pair of second fastener holes of the second plurality of fastener holes defined by the upper and lower plates; and
adjustment of the angular orientation of the first support arm relative to the mounting bracket results in an angular orientation of the ground-engaging tool being adjusted relative to the row unit frame.

9. The agricultural system of claim 7, wherein:
the first support arm includes a base defining a third fastener hole;
the second support arm defines a third plurality of fastener holes and is oriented such that the third plurality of fastener holes are spaced apart along a vertical direction of the row unit frame, the second support arm configured to be adjusted in the vertical direction relative to the first support arm by aligning the third fastener hole of the first support arm with one of the fastener holes of the third plurality of fastener holes of the second support arm; and
adjustment of the position of the second support arm relative to the first support arm in the vertical direction results in the position of the ground-engaging tool being adjusted in the vertical direction relative to the row unit frame.

10. The agricultural system of claim 1, wherein:
the first support arm is configured to be pivotably coupled to the mounting bracket about a pivot axis to adjust an angular orientation of the first support arm relative to the mounting bracket; and
adjustment of the angular orientation of the first support arm relative to the mounting bracket results in an angular orientation of the ground-engaging tool being adjusted relative to the row unit frame.

11. The agricultural system of claim 1, wherein the ground-engaging tool comprises a coulter disc.

12. An agricultural implement, comprising:
a toolbar;
a row unit coupled to the toolbar, the row unit including a row unit frame;
a coulter disc configured to engage soil of a field as the agricultural implement traverses the field;
a mounting assembly configured to support the coulter disc relative to the row unit frame, the mounting assembly comprising:
a mounting bracket coupled to the row unit frame, the mounting bracket configured to be positionally adjusted relative to the row unit frame to adjust a position of the coulter disc relative to the row unit frame in a first direction, the mounting bracket comprising:
a mounting plate;
an upper plate rigidly coupled to the mounting plate; and
a lower plate rigidly coupled to the mounting plate;
a first support arm coupled to the mounting bracket between the upper plate and the lower plate, the first support arm configured to be positionally adjusted relative to the mounting bracket to adjust the position of the coulter disc relative to the row unit frame in a second direction differing from the first direction; and
a second support arm coupled between the first support arm and the coulter disc, the second support arm configured to be positionally adjusted relative to the first support arm to adjust the position of the coulter disc relative to the row unit frame in a third direction differing from the first and second directions.

13. The agricultural implement of claim 12, wherein the second direction extends perpendicular to the first direction and the third direction extends perpendicular to both the first direction and the second direction.

14. The agricultural implement of claim 13, wherein the first direction comprises a fore-aft direction of the row unit, the second direction comprises a lateral direction of the row unit, and the third direction comprises a vertical direction of the row unit.

15. The agricultural implement of claim 12, wherein:
one or more fasteners extend through the mounting bracket, the one or more fasteners coupling the mounting plate to a portion of the row unit frame and being configured to allow a position of the mounting bracket to be adjusted along the row unit frame in a fore-aft direction of the row unit, and
adjustment of the position of the mounting bracket relative to the row unit frame in the fore-aft direction results in the position of the coulter disc being adjusted in the fore-aft direction.

16. The agricultural implement of claim 12, wherein:
the upper plate and the lower plate are positioned relative to each other in a vertical direction such that the first support arm is received therebetween and coupled to the upper plate and the lower plate.

17. The agricultural implement of claim 12, wherein:
the upper plate and the lower plate each define a first plurality of fastener holes and are each oriented such that the first plurality of fastener holes are spaced apart along a lateral direction of the row unit;
the first support arm defines a first fastener hole and is configured to be adjusted in the lateral direction relative to the mounting bracket by aligning the first fastener hole with an aligned pair of first fastener holes of the first plurality of fastener holes defined by the upper and lower plates; and
adjustment of the position of the first support arm relative to the mounting bracket in the lateral direction results in the position of the coulter disc being adjusted in the lateral direction.

18. The agricultural implement of claim 17, wherein:
a pivot axis is defined between the first support arm and the mounting bracket via a fastener extending through the first fastener hole and the aligned pair of first fastener holes;
the upper plate and the lower plate each define a second plurality of fastener holes and are oriented such that the second plurality of fastener holes are spaced apart along the lateral direction of the row unit;
the first support arm defines a second fastener hole and is configured to be pivoted about the pivot axis to adjust an angular orientation of the first support arm relative to the mounting bracket by aligning the second fastener hole with an aligned pair of second fastener holes of the second plurality of fastener holes defined by the upper and lower plates; and
adjustment of the angular orientation of the first support arm relative to the mounting bracket results in an angular orientation of the coulter disc being adjusted relative to the row unit frame.

19. The agricultural implement of claim 17, wherein:
the first support arm includes a base defining a third fastener hole;
the second support arm defines a third plurality of fastener holes and is oriented such that the third plurality of fastener holes are spaced apart along a vertical direction of the row unit frame, the second support arm being configured to be adjusted in the vertical direction relative to the first support arm by aligning the third fastener hole of the first support arm with one of the fastener holes of the third plurality of fastener holes of the second support arm; and
adjustment of the position of the second support arm relative to the first support arm in the vertical direction results in the position of the coulter disc being adjusted in the vertical direction relative to the row unit frame.

20. The agricultural implement of claim 12, wherein:
the first support arm is configured to be pivotably coupled to the mounting bracket about a pivot axis to adjust an angular orientation of the first support arm relative to the mounting bracket; and
adjustment of the angular orientation of the first support arm relative to the mounting bracket results in an angular orientation of the coulter disc being adjusted relative to the row unit frame.
